(19) United States
(12) Patent Application Publication
(10) Pub. No.: US 2016/0035032 A1
(43) Pub. Date: Feb. 4, 2016

(54) DETERMINING AN ASSET RECOMMENDATION

(71) Applicant: The Motley Fool Holdings, Inc., Alexandria, VA (US)

(72) Inventors: Ian Alexander TWOMBLY, Santa Clara, CA (US); Alexander Pape, Arlington, VA (US)

(73) Assignee: The Motley Fool Holdings, Inc., Alexandria, VA (US)

(21) Appl. No.: 14/447,228

(22) Filed: Jul. 30, 2014

(51) Int. Cl. G06Q 40/06

(52) U.S. Cl. CPC G06Q 40/06

(57) ABSTRACT

Disclosed herein are system, apparatus, article of manufacture, method and/or computer program product embodiments for determining an asset recommendation. An embodiment operates by iteratively removing asset categories from an asset category allocation and determining an asset to recommend based on one or more remaining asset categories in the asset category allocation.

### BACKGROUND

Providing recommendations of assets to add to or replace in a portfolio is becoming increasingly more computationally complex. However, this complexity typically involves a trade-off between the quality of the recommendation and time it takes to generate the recommendation. Attempting to generate high quality recommendations that both meet user requirements and meet performance metrics is often time-intensive. Similarly, approaches that seek to decrease the time it takes to make recommendations often produce suggested assets that do not satisfy either user requirements or performance goals.

### SUMMARY

Provided herein are system, apparatus, article of manufacture, method and/or computer program product embodiments, and/or combinations and sub-combinations thereof, for determining an asset recommendation.

An embodiment includes a method for determining an asset recommendation. The method operates by iteratively removing asset categories from an asset category allocation and determining an asset to recommend based on one or more remaining asset categories in the asset category allocation.

Another embodiment includes an apparatus for determining an asset recommendation. The apparatus includes a memory and at least one processor coupled to the memory. The processor is configured to iteratively remove asset categories from an asset category allocation and determine an asset to recommend based on one or more remaining asset categories in the asset category allocation.

A further embodiment includes a tangible computer-readable device having instructions stored thereon that, when executed by at least one computing device, cause the computing device to perform operations. The operations include iteratively removing asset categories from an asset category allocation and determining an asset to recommend based on one or more remaining asset categories in the asset category allocation.

### BRIEF DESCRIPTION OF THE DRAWINGS

The accompanying drawings are incorporated herein and form a part of the specification.

FIG. 1 is a block diagram of a system for determining a portfolio asset recommendation, according to an example embodiment.

FIG. 2 is a flowchart illustrating a process for determining a portfolio asset recommendation, according to an example embodiment.

FIG. 3 is a flowchart illustrating a process for iteratively removing asset categories from an asset category allocation, according to an example embodiment.

FIG. 4 is a block diagram of example asset category allocations, according to an example embodiment.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

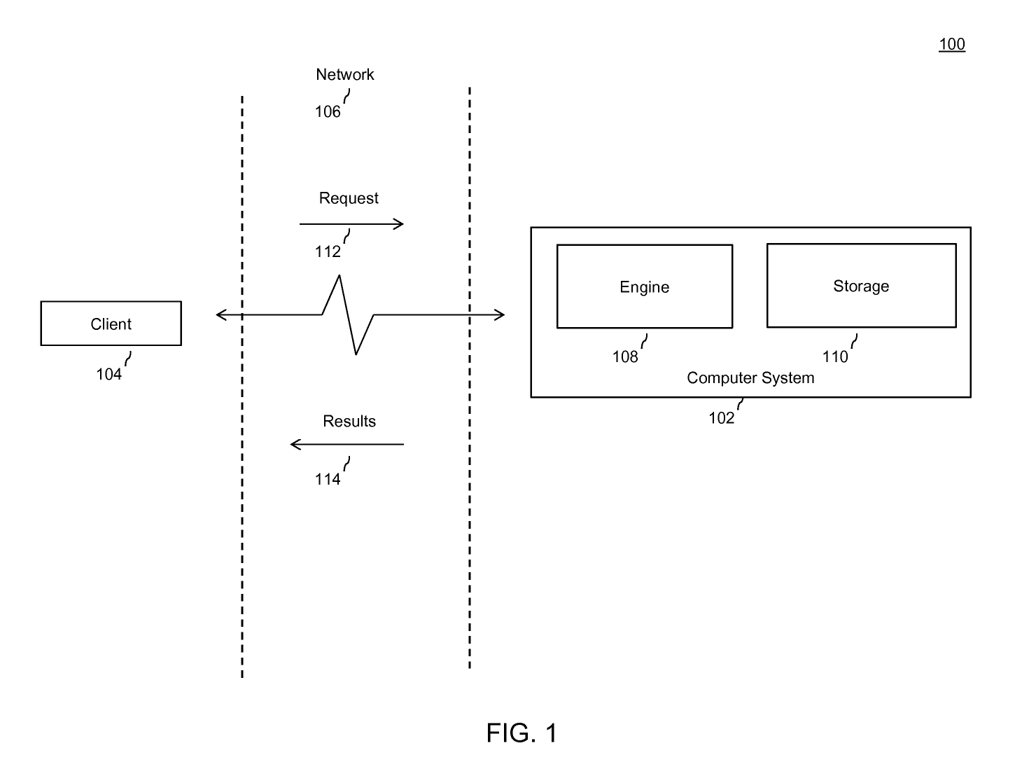

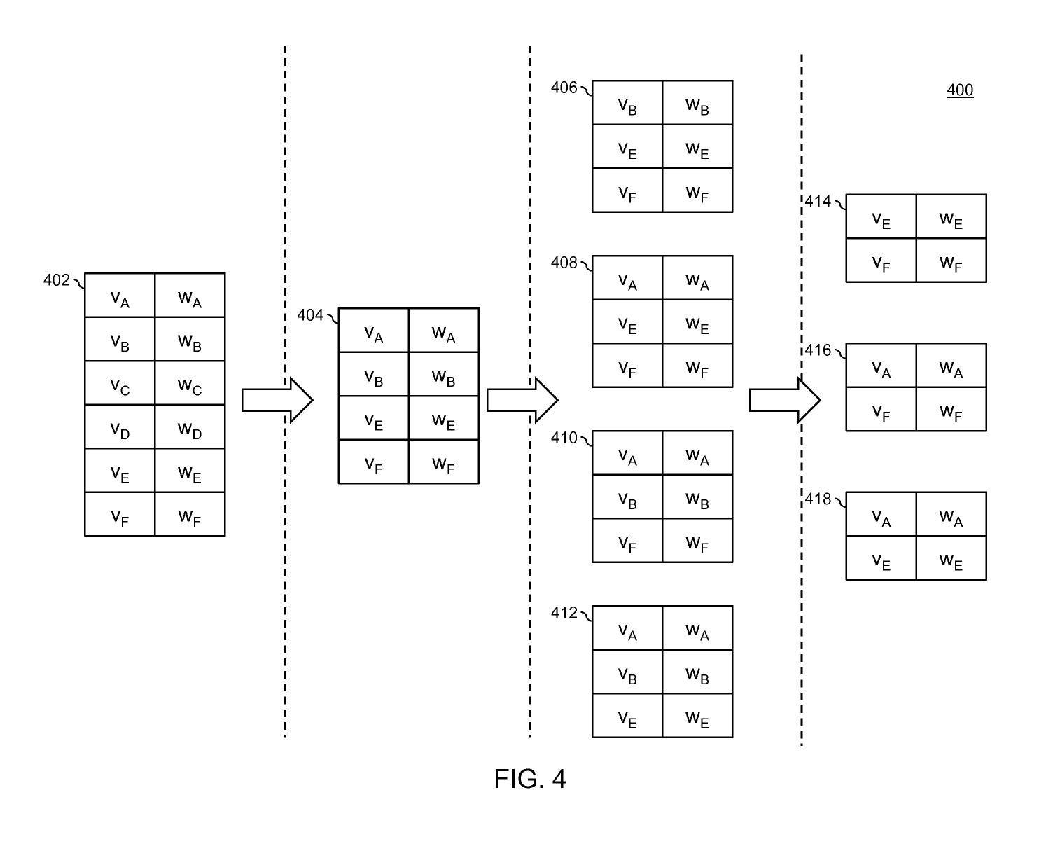

FIG. 1 is a block diagram of a system 100 that includes a computer system 102 and client 104 that communicates with computer system 102. Computer system 102 may be a system executing on a server and accessible to client 104 over a network, such as network 106, described below. Although client 104 is represented in FIG. 1 as a separate physical machine from computer system 102, this is presented by way of example, and not limitation. In an additional embodiment, client 104 occupies the same physical system as computer system 102. In a further embodiment, client 104 is a software application that accesses computer system 102. In another embodiment, a user may operate client 104 to request access to computer system 102. Throughout this specification, the term client will be used to refer to any hardware or software. Additionally, computer system 102, client 104, or both computer system 102 and client 104 may execute within a computer system, such as an example computer system discussed in FIG. 4.

Computer system 102 and client 104 may communicate over network 106. Network 106 may be any network or combination of networks that can carry data communications. Such a network 106 may include, but is not limited to, a local area network, metropolitan area network, and/or wide area network, e.g. the Internet.

Computer system 102 includes engine 108 and storage 110. Engine 108 may be any combination of hardware or software configured to determine a portfolio asset recommendation. Storage 110 may be any combination of hardware or software configured to store one or more values used by engine 108 when determining a portfolio asset recommendation. For example, storage 110 can information relating to one or more portfolios, assets, asset allocations, goals, or any combination thereof.

In an embodiment, computer system 102 receives request 112 for determining an asset recommendation. Request 112 can include one or more of an asset allocation, an asset, a desired target allocation, assets or asset categories to exclude or include from the recommendation, or any other information used for providing an asset recommendation.

An asset may refer to an economic resource, including anything tangible or intangible that is capable of being owned or controlled to produce value or that is held to have positive economic value. Example assets include but are not limited to stocks, bonds, mutual funds, securities, cash, cash equivalents, inventory, receivables, and the like.

An asset allocation may refer to a collection of assets, such as a portfolio. An asset allocation can specify one or more assets that make up the allocation and the distribution of those assets. The distribution can be specified by the proportion of an asset to the asset allocation, the number of shares of an asset, the value of an asset in the asset allocation, the volume of an asset in the asset allocation, or any combination thereof. In an embodiment, the distribution of an asset in an allocation is represented by a weight, e.g. the proportion of the asset in the allocation.

An asset category may refer to a grouping of one or more assets. An asset category can be defined by one or more attributes. In an embodiment, an asset category is defined by an actual or desired market capitalization (e.g. micro, small, or large), an actual or desired market style (e.g. value, blended, or growth, a Morning Star categorization), an actual or desired sector (e.g. Consumer Discretionary, Consumer Staples, Energy, Financials, Health Care, Industrials, Technology, Materials, Telecommunications, and Utilities), an analyst rating (e.g. buy, strong buy, hold, sell, strong sell, etc.), or any combination thereof.

In an embodiment, an asset category is represented by a vector, in which vector includes one or more values specifying the presence or absence of the one or more attributes that define the asset category. For example, a category may be represented by the example vector v=<0,0,1,1,0,0,1,0,0,0,0,0,0,0,0,0,0,1>, in which the first three vectors values correspond to market capitalization attributes, the following three vector values correspond to market style attributes, the following ten vector values correspond to sector designations, and the last two value values correspond to analyst recommendations. In this example, the category defined by the vector corresponds to assets that are large cap, value assets in the technology sector that have a “strong buy” analyst recommendation. Alternatively or additionally, each asset category can be represented by one or more other data structures.

In an embodiment, an asset category is represented by a vector including one or more values that correspond to partially having one or more attributes. Some assets (such as stocks, mutual funds, Exchange Traded Funds, spiders, etc.) may include a mix of attribute component types. For example, a stock that is a that blend between growth and value may have an growth attribute that equals “0.5” and a value attribute that equals “0.5.” As another example, a mutual fund that includes a number of assets from many sectors may have partial attribute values for each of the sector attributes represented by the fund. The fund may be represented by, for example, the example vector v₂=<0,0,1,1,0,0,0.5, 0, 0, 0.2, 0, 0, 0, 0, 0, 0.3, 0, 1>, in which 50% of the mutual fund's assets are in the Consumer Discretionary sector, 20% of the mutual fund's assets are in the Financials sector, and 30% of the mutual fund's assets are in the Utilities sector.

In an embodiment, vector attribute values may be subject to certain normalization constraints. For example, all the different Market Capitalization components, Style components, and Sector components must each respectively sum to 1 or 100%. This indicates that the attribute values cover 100% of the data inside the asset. Although summing to 1 or 100% is discussed, embodiments of the invention support other attribute value constraints.

The use of partial attribute values is distinct from the weighting applied to the vector that equally changes the actual values associated with the vector. Weighting is further discussed below.

Although example vectors have been depicted with a particular format, embodiments of the invention support any number or type of vector values, vector formats, attributes represented by the values, or meaning ascribed to the values. For example, vector values can be discrete, continuous, negative, or any combination thereof, and an attribute can be represented by one or more vector values.

An asset category allocation may refer to a collection of one or more asset categories. An asset category allocation can specify one or more asset categories that make up the asset category allocation and the distribution of those asset categories. The distribution can be specified by the proportion of an asset category to the asset category allocation, the number of shares of an asset category, the value of an asset category in the asset allocation category, the volume of an asset category in the asset category allocation, or any combination thereof. In an embodiment, the distribution of an asset category in an asset category allocation is represented by a weight, e.g. the proportion of the category asset in the allocation.

In an embodiment, an asset category allocation is represented by a vector, in which vector includes one or more values specifying the presence or absence of the one or more attributes that define the asset category. A vector representing an asset category allocation can include any of the variations discussed above regarding a vector representation of an asset category.

In an embodiment, computer system 102 transmits results 114. Results 114 can include one or more asset recommendations, assets, asset categories, guidance relating to the recommendation, or any combination thereof.

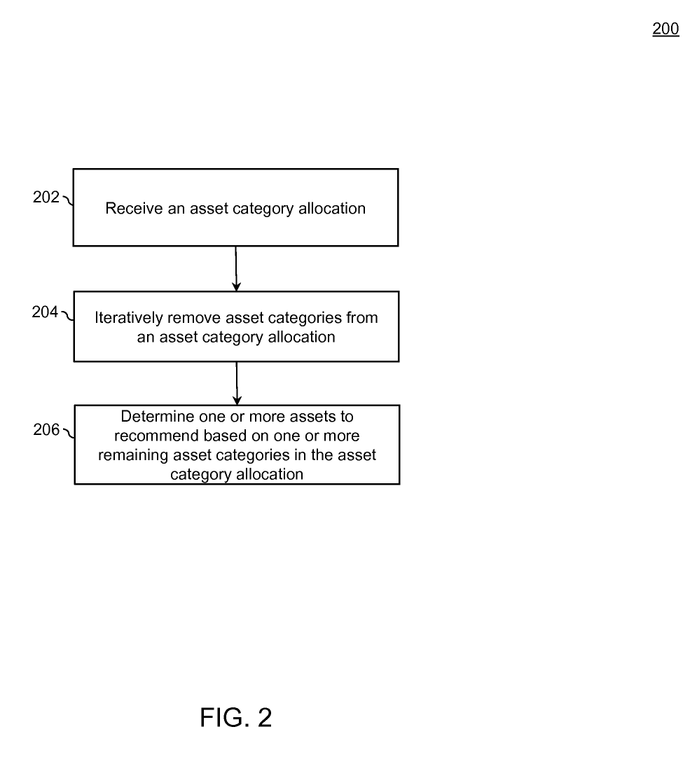

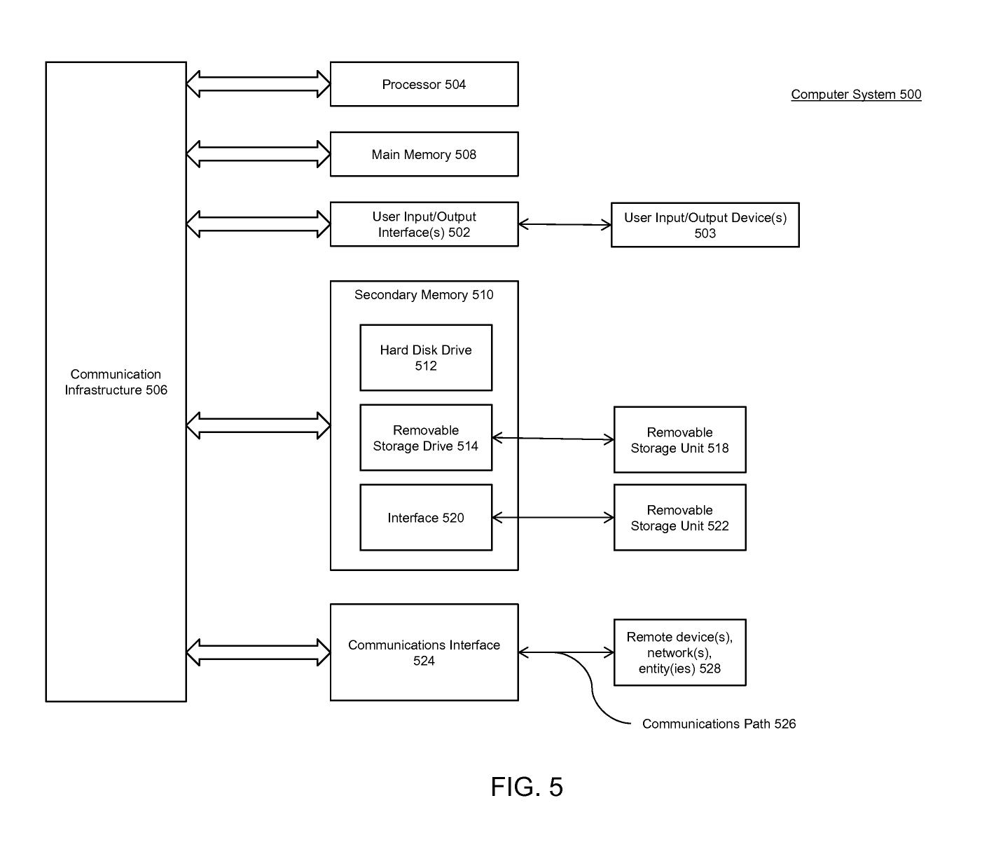

FIG. 2 is a flowchart illustrating a process 200 for determining an asset recommendation, according to an example embodiment. Process 200 can be performed by processing logic that can comprise hardware (e.g., circuitry, dedicated logic, programmable logic, microcode, etc.), software (e.g., instructions run on a processing device), or a combination thereof. For example, process 200 may be performed by computer system 102 or the computer system depicted in FIG. 5.

In block 202, an asset category allocation is received. In an embodiment, computer system 102 receives the asset category allocation. The asset category allocation can be received, for example, from client 104, storage 110, another source, or any combination thereof.

In an embodiment, the asset category allocation is created based on an asset allocation. The one or more assets in the asset allocation can be converted into one or more asset categories. For example, both Apple and Google stocks may be converted into and represented by an asset category of a large cap, value assets in the technology sector that have a “buy” analyst rating. Thus, in a portfolio having Apple stock, Google stock, or both, these assets can both be converted into the asset category discussed above. In an embodiment, the asset category can be weighted by the combined weights of the assets it replaces, e.g. the sum of the weights. In an embodiment, an asset category allocation can be created by converting the assets from an asset allocation into asset categories and weighting the resulting asset categories accordingly.

In an embodiment, the asset category allocation is recreated based on the asset allocation or a different asset allocation. As market conditions change, the categorization of assets, as well as the asset allocation, may be subject to change. For example, an example asset B could lose enough market share to change from a large cap to a small cap asset. In this example, the asset category of B changes. As another example, due to market conditions, the amount of B in the asset allocation may change. In either of these examples, the asset category allocation may can be recreated to reflect changes to the assets or categories.

In an embodiment, the asset category allocation is created from an asset allocation that has undergone some optimization. For example, the asset allocation can be a model portfolio produced to achieve one or more objectives, such as having a high or best rate of return over a given time frame, a high or best expected rate of return in a future time frame, or any other model portfolio. An asset category allocation created based on a model portfolio can capture some, if not all, of the desired characteristics that made the model portfolio of interest.

In an embodiment, the asset category allocation is subjected to further processing, such as by computer system 102. For example, one or more asset categories in the asset category allocation that are to be replaced can be weighted by zero or some other weight that minimizes the impact of those asset categories in the allocation. As another example, the weights of one or more asset categories in the allocation can be re-weighted, scaled, smoothed, or any combination thereof.

In block 204, asset categories are iteratively removed from an asset category allocation. In an embodiment, computer system 102 iteratively removes asset categories from an asset category allocation.

In an embodiment, the asset category allocation is subjected to processing during or between iterations, such as by computer system 102. For example, one or more asset categories in the asset category allocation that are to be removed from the allocation can be weighted by zero or some other weight that minimizes the impact of those asset categories in the allocation. As another example, the weights of one or more asset categories in the allocation can be re-weighted, scaled, smoothed, or any combination thereof.

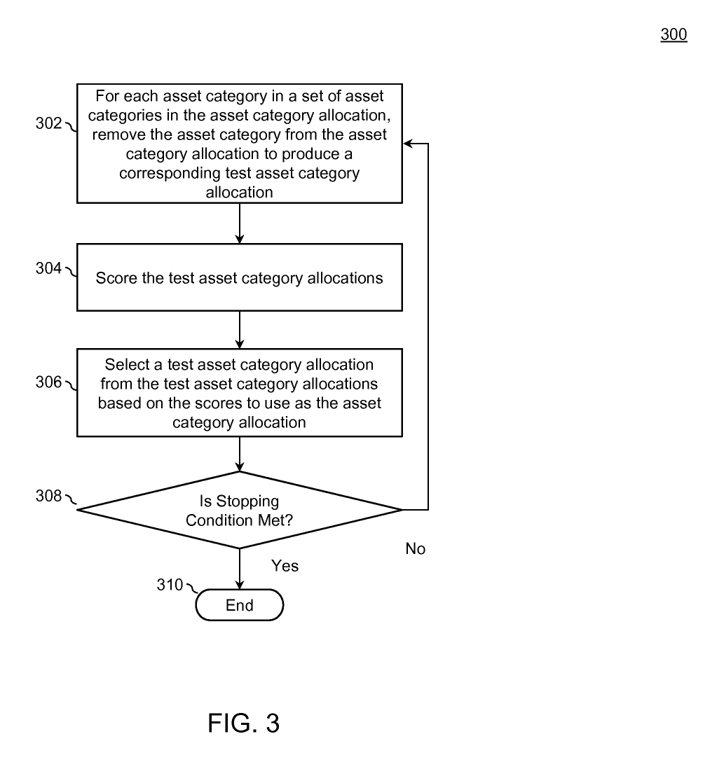

In an embodiment, asset categories are iteratively removed according to the process 300 depicted in FIG. 3. Although process 300 depicts an embodiment for iteratively removing asset categories from an asset category allocation, embodiments of the invention support other processes for iteratively removing asset categories from an asset category allocation. Process 300 is further discussed below.

Referring back to FIG. 2, in block 206, one or more assets to recommend may be determined based on one or more remaining asset categories in the asset category allocation. In an embodiment, computer system 102 determines the one or more assets to recommend based on one or more remaining asset categories in the asset category allocation. For each asset category in the remaining asset categories, an asset of that asset category may be selected as the recommendation. The asset can be selected arbitrarily or randomly from all of the assets in the category. Alternatively, the asset can be selected based on a preferred asset in the category. In an embodiment, one or more assets in the category that are already in a portfolio may be excluded from being selected as a recommendation.

In an embodiment, the recommendation also specifies an amount of the asset to purchase. The amount can be expressed as a number of shares of the asset, a value of the asset, a percentage of the portfolio that the asset is to comprise, or any combination thereof. The amount of the asset may be determined based on the weighting of the asset's category as one or more of the remaining asset categories in the asset category allocation.

In an embodiment, one or more recommendations may be presented to a user for selection to add to or as a replacement in the user's portfolio. The recommendation may remain static for a period of time, and may be replaced with another recommendation. A new recommended asset may be determined, for example, if the user indicates that the user is not interested in the current recommendation, if the assets or asset allocation of the user's portfolio changes, if market conditions change, or any combination thereof.

FIG. 3 is a flowchart illustrating a process 300 for iteratively removing asset categories from an asset category allocation, according to an example embodiment. Process 300 can be performed by processing logic that can comprise hardware (e.g., circuitry, dedicated logic, programmable logic, microcode, etc.), software (e.g., instructions run on a processing device), or a combination thereof. For example, process 300 may be performed by computer system 102 or the computer system depicted in FIG. 5.

In block 302, for each asset category in a set of asset categories in the asset category allocation, an asset category is removed from the asset category allocation to produce a corresponding test asset category allocation. In an embodiment, computer system 102 removes the asset category from the asset category allocation.

In block 304, the test asset category allocations are scored. In an embodiment, computer system 102 scores the test asset category allocations. The test asset category allocations can be scored against a target criteria. The target criteria can include, for example, a target asset category allocation. The target asset category allocation may be based on a user's portfolio. The target allocation can include the assets that are not subject to being removed or replaced by one or more recommendations, as well as weights that reflect the allocation of the respective assets of the target allocation.

In an embodiment, scoring the test asset category allocations further comprises weighting attributes corresponding to the one or more asset categories in the test asset category allocation, determining weighted attributes for the test asset category allocation based on the weighted attributes corresponding to the one or more asset categories, and producing a score based on the weighted attributes for the test asset category allocation and target criteria.

In an embodiment and as discussed above, attributes of the asset categories can include, for example, a market capitalization, market style, market sector, and rating, and the asset categories can be represented by a vector that encodes these attributes. Similarly, the assets of the target asset category allocation can be represented by vectors, and each vector may be associated with a weight.

In an embodiment, weighting attributes corresponding to the one or more asset categories in the test asset category allocation involves applying the weight corresponding to the asset category to the attributes in a vector representing the asset category. For example, a vector v=<0,0,1,1,0,0,1,0,0,0,0,0,0,0,0,0,0,1> that represents an asset category, when weighted by a weight of 0.3 would result in vector v′=<0,0,0.3, 0.3,0,0, 0.3,0,0,0,0,0,0,0,0,0,0, 0.3>. Although the preceding discusses weighting asset categories in a test asset category allocation, asset categories in a target asset category allocation may be similarly weighted.

In an embodiment, determining weighted attributes for the test asset category allocation based on the weighted attributes corresponding to the one or more asset categories involves combining the weighted vectors corresponding to the asset categories to produce a vector representative of the test asset category allocation. For example, a test asset category allocation having weighted category asset vectors v₁, v₂, . . . , v₁₀ can be represented by v_{TEST}=v₁+v₂+ . . . v₁₀. Although the preceding discusses combining asset categories in a test asset category allocation to produce a vector (e.g. v_{TEST}) representative of the test asset category allocation, a vector (e.g. v_{TARGET}) representative of the target asset category allocation can also be created.

In an embodiment, producing a score based on the weighted attributes for the test asset category allocation and target criteria involves comparing the vector representative of the test asset category allocation (e.g. v_{TEST}) to the vector representative of the target asset category allocation (e.g. v_{TARGET}). For example, a distance metric (e.g. Euclidean distance) between the vector representative of the test asset category allocation to the vector representative of the target asset category allocation. An example distance metric can be calculated using the following equation: distance=sqrt((v_{TARGET}[0]−v_{TEST}[0])²+(v_{TARGET}[1]−v_{TEST}[1])²+ . . . +(v_{TARGET}[n]−v_{TEST}[n])²), where n represents the number of attributes in the vector. Decreasing distance metric values may correspond to increasingly similar test and target asset category allocations. The distance metric can be used as the score for the test asset category allocation.

In block 306, a test asset category allocation is selected to use as the asset category allocation from the test asset category allocations based on the scores. In an embodiment, computer system 102 selects a test asset category allocation from the test asset category allocations based on the scores to use as the asset category allocation. The test asset category allocation can be selected based on having the best score or one of the top performing scores. For example, when using a distance metric as the score for the test asset category allocation, the best score or one of the top performing scores is the score with the lowest or lower value that the other scores.

In block 308, it is determined whether the stopping condition is met. In an embodiment, computer system 102 determines whether the stopping condition is met. If the stopping condition is met, process 300 proceeds to block 310 and ends. If the stopping condition is not met, process 300 proceeds to block 302 and begins another iteration.

In an embodiment, the stopping condition is used to determine when to stop iterating through process 300, and can include one or more conditions. For example, the stopping condition can be that a predetermined number of asset categories remaining in the asset category allocation has been met. As a result, process 300 may repeat removing asset categories from the asset category allocation until the asset category allocation has a predetermined number of remaining asset categories. As another example, the stopping condition can be a number of iterations of process 300. As a result, process 300 may repeat removing asset categories from the asset category allocation until a certain number of iterations has occurred. As yet another example, the stopping condition can include any combination of conditions, such as those discussed above.

In an embodiment, at any point in process 300, the asset category allocation or test asset category allocations can be subject to further processing, including but not limited to weighting, re-weighting, scaling, smoothing, or any combination thereof. For example, one or more asset categories in the asset category allocation that are to be replaced can be weighted by zero or some other weight that minimizes the impact of those asset categories in the allocation. As another example, the weights of one or more asset categories in the allocation can be re-weighted, scaled, or smoothed.

FIG. 4 is a block diagram of example asset category allocations 400 used in process 200, according to an example embodiment, although it should be understood that process 200 is not limited to the example of FIG. 4, nor is the example of FIG. 4 limited to only applying process 200. FIG. 4 includes example asset category allocations 402, 404, 406, 408, 410, 412, 414, 416, and 418. Each asset category allocation includes one or more asset categories, which are represented by one or more vectors and their corresponding weights. However, embodiments of the invention support other representations of the asset category allocations, such as by one or more matrices, by incorporating the weights into the vectors as discussed above, or without the use of vectors or matrices. In the example of FIG. 4, two asset categories are sought as a recommendation.

Asset category allocation 402 includes vectors and weights for asset categories A, B, C, D, E, and F. In the example of FIG. 4, it is known that asset categories C and D will not be the basis for valid recommendations. For example, the user may already have assets from categories C and D in the user's portfolio and is interested in other asset types. Thus, these asset categories are removed consideration, for example by computer system 102, resulting in asset category allocation 404.

Asset category allocation 404 includes remaining asset categories A, B, E, and F. Asset categories from asset category allocation 404 can be iteratively removed. For example, test asset allocations 406, 408, 410, and 412 can be produced by removing each of the asset categories from asset category allocation 404. Asset category allocation 406 is a test asset category allocation with asset category A removed, asset category allocation 408 is a test asset category allocation with asset category B removed, asset category allocation 410 is a test asset category allocation with asset category E removed, and asset category allocation 412 is a test asset category allocation with asset category F removed. Each of the test asset category allocations 406, 408, 410, and 412 can be scored, such as by using the scoring methods discussed herein. In the example of FIG. 4, test asset category allocation 408 has a score that reflects it is most similar to a target portfolio, and is selected to be used as the asset category allocation in subsequent iterations. Because there are still three asset categories in asset category allocation 408, the stopping condition of two asset categories in the allocation is not met, and the process continues with another iteration.

In the next iteration, test asset allocations 414, 416, and 418 can be produced by removing each of the asset categories from asset category allocation 408. Asset category allocation 414 is a test asset category allocation with asset category A removed, asset category allocation 416 is a test asset category allocation with asset category E removed, and asset category allocation 418 is a test asset category allocation with asset category F removed. Each of the test asset category allocations 414, 416, and 418 can be scored, such as by using the scoring methods discussed herein. In the example of FIG. 4, test asset category allocation 416 has a score that reflects it is most similar to a target portfolio, and is selected to be used as the asset category allocation in subsequent iterations. Because there are two asset categories in asset category allocation 416, the stopping condition of two asset categories in the allocation is met, and the iterations end. Asset category allocation 416 may then be used to recommend an asset from category A and an asset from category F.

### Example Computer System

Various embodiments can be implemented, for example, using one or more well-known computer systems, such as computer system 500 shown in FIG. 5. Computer system 500 can be any well-known computer capable of performing the functions described herein, such as computers available from International Business Machines, Apple, Sun, HP, Dell, Sony, Toshiba, etc. Embodiments of the invention (or portions thereof) can also be implemented using hardware state machines, application-specific integrated circuits (ASIC) and/or other hardware components specifically configured to perform the operations described herein.

Computer system 500 includes one or more processors (also called central processing units, or CPUs), such as a processor 504. Processor 504 is connected to a communication infrastructure or bus 506.

One or more processors 504 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 500 also includes user input/output device(s) 503, such as monitors, keyboards, pointing devices, etc., which communicate with communication infrastructure 506 through user input/output interface(s) 502.

Computer system 500 also includes a main or primary memory 508, such as random access memory (RAM). Main memory 508 may include one or more levels of cache. Main memory 508 has stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 5. In particular, embodiments may operate with software, hardware, and/or operating system implementations other than those described herein.

### CONCLUSION

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A method, comprising:
iteratively removing, by at least one processor, asset categories from an asset category allocation;
determining, by the at least one processor, an asset to recommend based on one or more remaining asset categories in the asset category allocation.

2. The method of claim 1, the iteratively removing further comprising:
for each asset category in a set of asset categories in the asset category allocation, removing the asset category from the asset category allocation to produce a corresponding test asset category allocation;
scoring the test asset category allocations; and
selecting a test asset category allocation from the test asset category allocations based on the scores to use as the asset category allocation; and
repeating the removing, scoring, and selecting.

3. The method of claim 2, the scoring further comprising:
weighting attributes corresponding to the one or more asset categories in the test asset category allocation;
determining weighted attributes for the test asset category allocation based on the weighted attributes corresponding to the one or more asset categories; and
producing a score based on the weighted attributes for the test asset category allocation and target criteria.

4. The method of claim 3, wherein the criteria corresponding to the one or more asset categories and the target criteria are represented by vectors.

5. The method of claim 3, the wherein the criteria corresponding to the one or more asset categories or the target criteria comprise a market capitalization, sector, style, and an analyst recommendation.

6. The method of claim 1, the repeating further comprising:
repeating the removing until the asset category allocation has a predetermined number of remaining asset categories.

7. The method of claim 1, further comprising:
generating, prior to the iteratively removing, the asset categories allocation from an asset allocation.

8. A system, comprising:
a memory; and
at least one processor coupled to the memory and configured to:
iteratively remove asset categories from an asset category allocation;
determine an asset to recommend based on one or more remaining asset categories in the asset category allocation.

9. The system of claim 8, wherein to iteratively remove, the at least one processor further configured to:
for each asset category in a set of asset categories in the asset category allocation, remove the asset category from the asset category allocation to produce a corresponding test asset category allocation;
score the test asset category allocations; and
select a test asset category allocation from the test asset category allocations based on the scores to use as the asset category allocation; and
repeat the removing, scoring, and selecting.

10. The system of claim 9, where to score, the at least one processor further configured to:
weight attributes corresponding to the one or more asset categories in the test asset category allocation;
determine weighted attributes for the test asset category allocation based on the weighted attributes corresponding to the one or more asset categories; and
produce a score based on the weighted attributes for the test asset category allocation and target criteria.

11. The system of claim 10, wherein the criteria corresponding to the one or more asset categories and the target criteria are represented by vectors.

12. The system of claim 10, the wherein the criteria corresponding to the one or more asset categories or the target criteria comprise a market capitalization, sector, style, and an analyst recommendation.

13. The system of claim 8, wherein to repeat, the at least one processor further configured to:
repeat the removing until the asset category allocation has a predetermined number of remaining asset categories.

14. The system of claim 8, the at least one processor further configured to:
generate, prior to the iteratively removing, the asset categories allocation from an asset allocation.

15. A tangible computer-readable device having instructions stored thereon that, when executed by at least one computing device, causes the at least one computing device to perform operations comprising:
iteratively removing asset categories from an asset category allocation;
determining an asset to recommend based on one or more remaining asset categories in the asset category allocation.

16. The computer-readable device of claim 15, the iteratively removing comprising:
for each asset category in a set of asset categories in the asset category allocation, removing the asset category from the asset category allocation to produce a corresponding test asset category allocation;
scoring the test asset category allocations; and
selecting a test asset category allocation from the test asset category allocations based on the scores to use as the asset category allocation; and
repeating the removing, scoring, and selecting.

17. The computer-readable device of claim 16, the scoring comprising:
weighting attributes corresponding to the one or more asset categories in the test asset category allocation;
determining weighted attributes for the test asset category allocation based on the weighted attributes corresponding to the one or more asset categories; and
producing a score based on the weighted attributes for the test asset category allocation and target criteria.

18. The computer-readable device of claim 17, wherein the criteria corresponding to the one or more asset categories and the target criteria are represented by vectors.

19. The computer-readable device of claim 17, the wherein the criteria corresponding to the one or more asset categories or the target criteria comprise a market capitalization, sector, style, and an analyst recommendation.

20. The computer-readable device of claim 15, the repeating comprising:
repeating the removing until the asset category allocation has a predetermined number of remaining asset categories.
